(19) United States
(12) Patent Application Publication
(10) Pub. No.: US 2023/0397761 A1
(43) Pub. Date: Dec. 14, 2023

(54) THERMOSTATIC CUP STRUCTURE

(71) Applicant: OESSO 5, LLC, Fairfield, IA (US)

(72) Inventors: Cliff Rose, Fairfield, IA (US); Edgar A. Shook, Fairfield, IA (US)

(21) Appl. No.: 17/839,564

(22) Filed: Jun. 14, 2022

(51) Int. Cl. A47J 36/24; A47G 19/22

(52) U.S. Cl. CPC A47J 36/2472; A47G 19/2272; A47G 19/2288

(57) ABSTRACT

A thermostatic cup structure that includes a cup body, a heating module and a base unit. The cup body is selectively attachable to the heating module and base unit. The base unit and heating module are structured such that they can accommodate cup bodies with different structures such as mugs, tumblers, and thermoses. Heating of the liquid within the cup body is powered by a swappable and rechargeable battery, contained in the base unit, that is connected to a heat plate through a conductive column. The ability to charge multiple base units anywhere USB-c power/adapters are available, and the fact that these base units are interchangeable with multiple variants of mugs (and can include thermoses, etc.) make this product unique in the market.

### BACKGROUND OF THE INVENTION

This invention is in regard to a temperature controlled cup, in particular, a thermostatic cup structure that automatically maintains the temperature of the liquid inside a cup body. The cup body, cup cover, heating module, and base unit can be separated and replaced. Furthermore, the invention can include locking features to ensure the cup body, base unit, and heating module do not accidentally separate after assembly and while in use by the operator.

In order to keep the liquid in the cup at a certain temperature, either warm or chilled, and, in order to be easy to carry with you, other cups have characteristics to make them easy to carry and keep warm (or keep cold). The methods utilized for cup insulation by these existing products is limited, and unless they are operated at very high temperature (or very low temperature), they are limited in achieving a stable, consumer friendly consistent liquid temperature for extended periods of time. When filled with liquids, at temperatures that the human body can withstand while drinking, the insulation does not prevent the return of the liquid to normal/room temperatures for very long.

As a result of this short duration of maintaining hot or cold desired liquid temperatures, some current beverage heater and cooler cups have developed automatically heated/cooled cups. Heaters and batteries are set in the cups so that the cups can maintain a fixed temperature for an extended duration of time; however, when the heaters and batteries of such cups are connected together, this results in an increase in the weight of the cups when carried and decrease the charging option of such cups

Furthermore, when cleaning the cups, it is also easy to cause moisture to seep into the heater and damage the heater and/or batteries. Although some prior beverage heater and cooler cups have developed products where heaters and cups can be separated, the heater element, battery and other control circuits are located in the base. The base and the cup in these products are held together via magnetic connections. This magnetic connection, while helping to prevent separation of the heater element and cup, are not conducive to the user to carry the product around. The magnetic connections are not strong, and prone to easy separation. Also, the magnetic forces are not strong, requiring that the heater element, use magnetic induction heating methods (similar to the principle of induction furnace heating metal pots). This heating method does not require the heater and the cup be in direct contact but is less efficient and results in high power usage and a poor heating effect. The magnetic base uses a wireless charging plate that reduces the portability of the cup.

It is therefore an object of the invention to provide a thermostatic cup structure that automatically maintains the temperature of the liquid in the cup body to a temperature selected by the user.

It is a further object of the invention to provide a cup body, heating module, and base unit that enables easy replacement, interchangeable and swapping of, the base unit, battery and heating module, to extend the lifespan of the product and enable easy cleaning and charging without worry of damage.

Yet another object of the invention is to ensure that the removable heating module and the base unit remain secure while being carried/transported and charged by the operator, and is interchangeable between different types of cups. This invention will lock to the mug, every 90 degrees, to accommodate both right-handed and left-handed consumers.

Yet another object of the invention is to ensure great flexibility to recharge the battery using USB-c fast charge technology, to allowing charging anywhere USB ports are available and allow for users to have multiple base units that can be charged and stored anywhere (at home, the office, in cars, etc.) enabling unlimited heating capability by quickly swapping out the base with a fully charged unit.

### SUMMARY OF THE INVENTION

A thermostatic cup structure comprised of a cup body, a heating module and a base unit. The cup body is fitted to the heating module; specifically a connecting recess surface on the cup body is connected to a convex connecting surface of the heating module ensuring that a heating plate of the heating module is selectively secured to a bottom of the cup body, and provides compressive forces to ensure that a first and secondary conductive columns are compressed and enable electrical connection between a battery,thru a control circuit board, to enable the heater module to heat the heating plate and provide heat to the bottom of the cup body.

The battery power of the base unit is transmitted to the heating plate via a circular conductive plate of the heating module, allowing the heating plate to generate heat to heat the liquid in the cup body, thus achieving the automatic maintenance of the temperature in the cup body. The ability to separate and replace the interchangeable base unit and/or heater module; also allow the mechanical interlocks to ensure that the thermostatic cup structure does not accidentally come apart when assembled by the operator.

In order to achieve the above purposes and efficacy, the technical means used in this creation include a cup body, a heating Module, and a base unit, wherein the cup body can be covered by a cup cover that can be selectively covered and separated. The cup body has an insulation layer between an inner and outer surface of the cup body.

The heating module consists of a heater body, a fixing plate, a heat shield, a heating plate, and a temperature sensor. The fixing plate is connected to the heater body and covers a connection hole. A bottom surface of the fixing plate is provided with a circular groove, and the circular groove mates to a circular conductive plate. A center of the conductive plate has a first conductive column.

The heat shield covers a top surface of the fixing plate. The heating plate covers the top surface of the heat shield and is electrically connected to the conductive plate.

The base unit is selectively separable from the heating module and comprises a shell (housing), a battery, a body, a control circuit board, an operation display module and a cover. The inside of the shell has a battery compartment, wherein the shell covers the outside of the battery, and is connected with the body. The control circuit board is connected to the body and electrically connected to the battery, and is provided with a plurality of secondary conductive column. A control chip is located on the control circuit board. The operation display module shows that the base unit is connected to the heater module and is electrically connected to the control circuit board.

When the cup body is fitted to the heating module, a convex connecting surface engages a connecting recess in the cup body to ensure that the heating plate comes into contact with the cup bottom. Furthermore, this action makes the heating plate compress a first conductive column and ensures the first of two contacts needed for full electrical contact. When the base unit is connected to the heating module, the interlocking of the engagement features ensure that a secondary conductive column is compressed. This allows electrical energy to flow from the battery (as controlled by the control circuit board) to the heating plate. The heat generated is then passed from the heating plate to the cup bottom which heats the liquid in the cup body. The shape and design of the heating module, locking method, and base unit, allows maximum adaptation to different mug bodies and for right-handed or left-handed consumers.

Thus, the automatic maintenance of the liquid temperature of the liquid contained in the cup body. The cup body, base unit, and heating module, can be separated and replaced, or interchangeable with different cups, and, after combination, due to the mechanical capture features, will not accidentally come apart while in use by the operator.

Also, a separate tea holder will enable this machine to brew, infuse, and control the temperature of tea. In another aspect a cooling insert can be used to keep cold liquids chilled for longer periods of time without diluting the liquid.

### BRIEF DESCRIPTION OF THE DRAWINGS

FIG. 1 is a perspective view of a first embodiment of the invention.

FIG. 2 is a perspective decomposition diagram of the first embodiment of the invention.

FIG. 3 is an exploded view of the heating module shown in FIG. 2.

FIG. 4 is an exploded view of the base unit shown in FIG. 2.

FIG. 5 is a perspective view of a sub-assembly utilized in the heating module, showing details of the locking features used when the base unit and heating module are connected by the operator.

FIG. 6 is a perspective view showing a cross section of the cup body, as assembled to the heating module and base unit.

FIG. 7 is an exploded view of the invention, and two additional parts used to make tea and chill liquids inside of the invention.

FIG. 8 is a perspective view of a first and second cup body designs that are interchangeable on a single base unit.

### DETAILED DESCRIPTION OF THE INVENTION

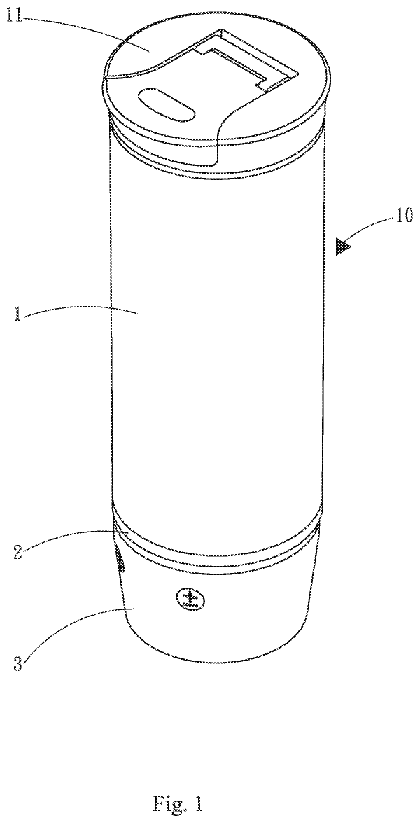

Now referring to the figures, FIGS. 1 through 6 show the structure of a first embodiment of a thermostatic cup 10 having a cup cover 11, a cup body 1, a heating module 2, and a base unit 3.

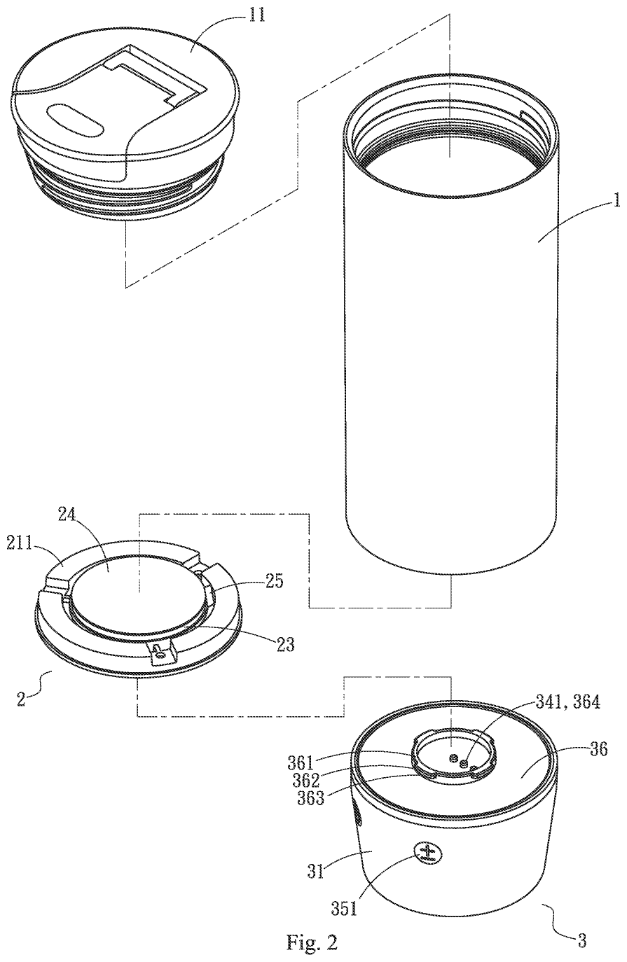

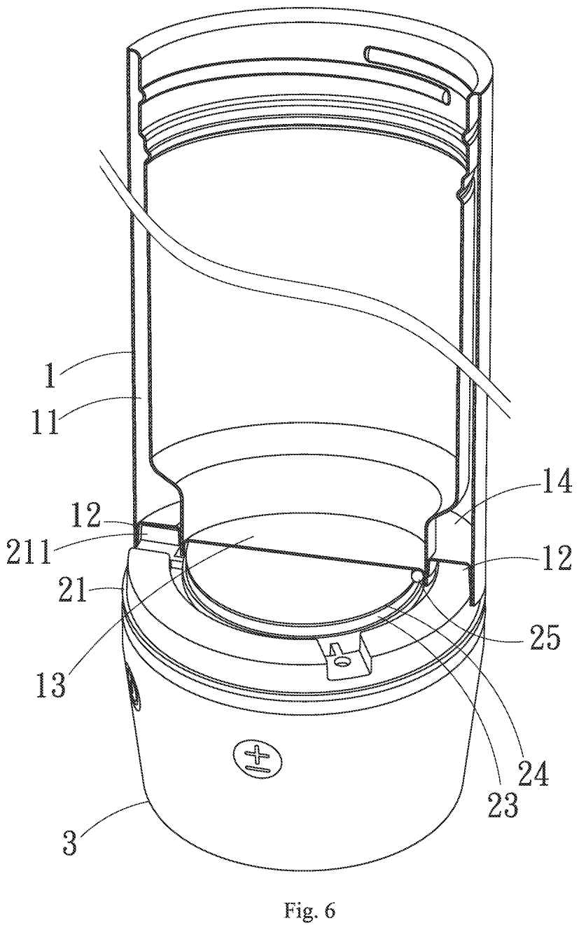

As shown in FIG. 2, the cup body 1 has a cup cover 11 that can be selectively separated and combined with the cup body 1. A bottom 13 of the cup body 1 has a connecting recess 12 as shown in FIG. 6. A vacuum sealed or insulated chamber between the inside and outside surface of the cup body 1 provides an insulation layer 14.

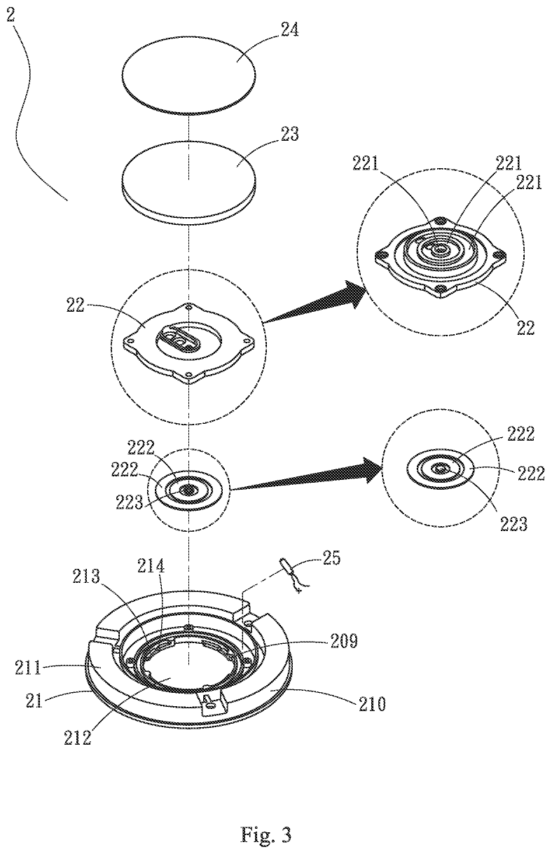

The heating module 2 (see FIG. 3) is attached to the bottom 13 of the cup body 1 and can be selectively separated and combined with the cup body 1. The heating module 2 comprises a heater body 21, a fixing plate 22, a heat shield 23, a heating plate 24 and a temperature sensor 25. The heater body 21 has a peripheral ring 210 that has a convex connecting surface 211. The interior of the heater body 21 a connection hole 212. An inner wall 209 of the heater body 21 has a buckle tab 213. The buckle tab 213 top face contains a buckle concave receiver feature 214, which locks the base unit 3 into place, when assembled to the heating module. Specifically, features 362 and 363 interface and lock to 213 and 214.

The fixing plate 22 is connected in the heater body 21 and covers the connection hole 212. The fixing plate 22 has a bottom surface that is provided with a ring groove 221. The ring groove 221 is set up in a ring conductive plate 222. A center of the conductive plate 222 provides a first conductive column 223.

It should be noted that the method of the fixing plate 22 being connected to the heater body 21 may be accomplished in a variety of manners, including locking screws, male thread locking, bonding, high-circumfuse wave plywood, etc. In the preferred embodiment, the heater body 21 and the fixing plate 22 are attached using screws, but could be accomplished in any manner.

As shown in FIG. 3, the heat shield 23 separates the heating Plate 24 from the fixing plate 22, to provide insulation both to the fixing plate 22 as well as the base unit 3. This feature serves to ensure that the battery 32 does not overheat, but also to help keep the exterior surfaces cool to the touch for the operator. The heating plate 24 covers the top surface of the heat shield 23 and is electrically connected with the circular conductive plate 222 and the first conductive column 223. Additionally, the temperature sensor 25 is connected to the surface of the heater body 21 and electrically connected with the circular conductive plate 222. In the current embodiment, the first conductive column 223 is set to be the common ground.

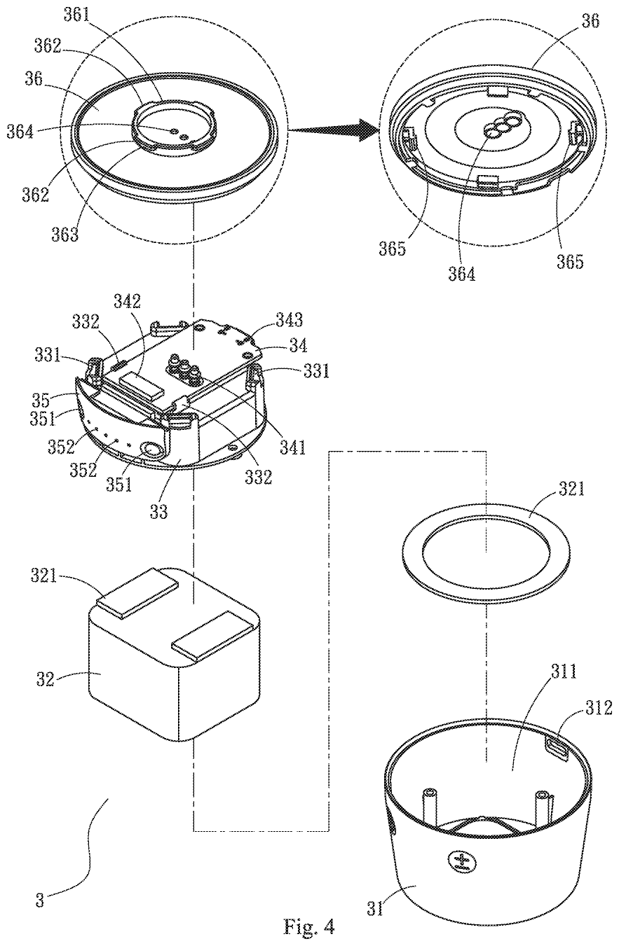

As best seen in FIG. 4, the base unit 3 can be selectively separated and connected to and from the heating module 2. The base unit 3 comprises a Shell 31, a battery 32, a body 33, a control circuit board 34, an operation display module 35, and a cover 36.

The shell 31 has a battery compartment 311 inside, a socket hole 312 on one side of the shell 31. The battery 32 is housed in the shell 31 within the battery compartment 311. The top and bottom of the battery 32 are connected with elastic connectors 321, which also are utilized to attach to the bottom inside surface of the shell 31 to minimize shaking and vibration. This feature allows the battery 32 to have a shock-proof, shock-absorbing or earthquake-resistant structure.

As shown in FIG. 4, the body 33 provides a cover for the battery 32 and is connected with the shell 31. The battery 32 is fixed in the shell 31, and the body 33 has a plurality of snap receivers 331, and a plurality of PCB Receivers 332 located on the top of the body 33. The control circuit board 34 sets into the PCB receivers 332 and is thereby connected to the body 33. Additionally, the control circuit board is also connected with the battery 32 electrical connection. The control circuit board has a plurality of secondary conductive columns 341, a control chip 342, and a port 343. When the control circuit board 34 is assembled into the shell 31, an external power cord will pass thru the socket hole 312 and plug into the port 343 to enable recharging of the internal battery 32. An operation display module 35 is connected to the side of the body 33 and electrically connected with the control circuit board 34. The operation display module 35 is equipped with a plurality of buttons 351 that control temperature and insulation time. The operation display module 35 also has an indicator 352 with a plurality of displays for indicating temperature status.

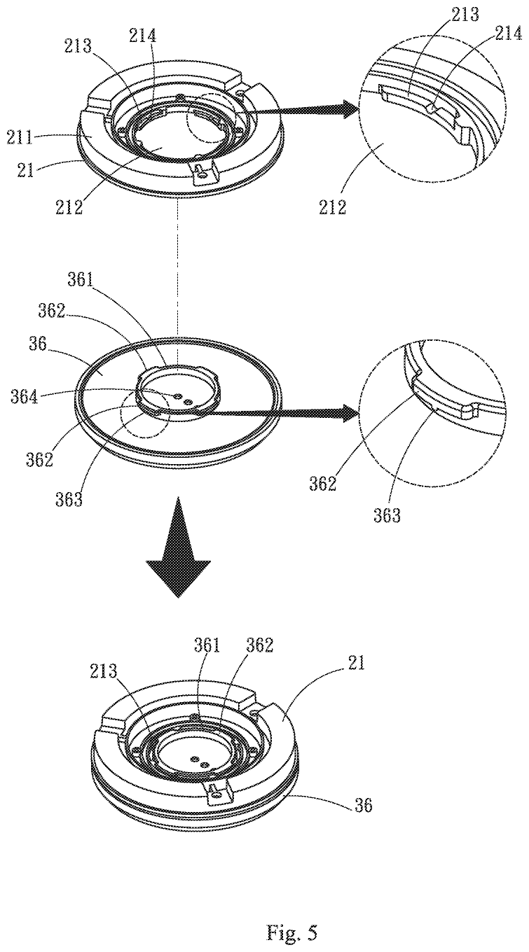

Again referring to FIGS. 4 and 5, the top of the base unit 3, has a cover 36 which has a connecting column 361. The extension around the connecting column 361 is provided with a plurality of base buckle tabs 362, the bottom surface of the base buckle tab 362 has a convex positioner 363. Additionally, the connection column 361 has a plurality of conductive column openings 364 for the secondary conductive column 341 to protrude through. A plurality of snap arms 365 connect the cover 36 into the plurality of snap receivers 331 of the body 33, which is attached to the shell 31.

When combining the cup body 1 with the heating module 2 as shown in FIG. 6, the convex connecting surface 211 of the heating module 2 sets into the connecting recess 12 of the cup body 1, such that the heating plate 24 makes positive contact against the cup bottom 13. In the preferred embodiment, the cup body 1 and the heating module 2 are assembled using screws, but they could be assembled in any number of ways including bonding, welding, etc. The ability to easily remove and replace the Heating Module 2 and also to have the heating module 2 provide a positive locking feature between the base unit 3, buckle tabs 362 and the buckle features 213 and the ability to quickly swap/replace the base unit 3, etc. are some of the novelties of the invention.

When combining the heating module 2 with the base unit 3 (see FIG. 2), the connecting column 361 of the base unit 3 passes through the connection hole 212 of the heating module 2, and by rotating either the base unit 3 or heating module 2, enables the base buckle tab 362 to interface with the buckle tab 213 to provide vertical orientation. Furthermore, when the base convex positioner 363 engages with the buckle concave receiver 214, the interaction will radially locate the two components together and provide a fixed “stop” and prevent accidental disassembly of the heating module 2 and the base unit 3. When the base unit 3 is located in this final position, then the control circuit board 34 via the secondary conductive column 341 will come into contact with the fixing plate 22, circular conductive plate 222 and the first conductive column 224, forming an electrical connection, enabling powering of the heating plate 24, which is in direct contact with the cup bottom 13, which allows the liquid inside the cup body 1 to be heated.

When using the preferred embodiment, the bottom of the cup body 1 is in contact with the heating module 2, and the heating module is connected to the base unit 3 as described above. This positioning allows the cup bottom 13 to produce downward pressure and make contact with the heating plate 24 and allows the heat shield 23 to drive the first conductive column 223 to form an activated state. Then, if the base unit 3 is installed, the battery 32 via the secondary conductive column 341 (controlled by the control circuit board 34), completes the circuit via connection thru the heating plate 24, thru the circular conductive plate 222. The electrical energy from the battery 32 is converted into thermal energy, which will subsequently heat the bottom 13 of the cup body 1 to warm the liquid inside the cup body 1.

The temperature of the heating (or insulation), the time of heating (or insulation), etc. can also be adjusted by operating the appropriate button 351 of the operation display module 35, and the current state of the operation can be deduced from indicator 352.

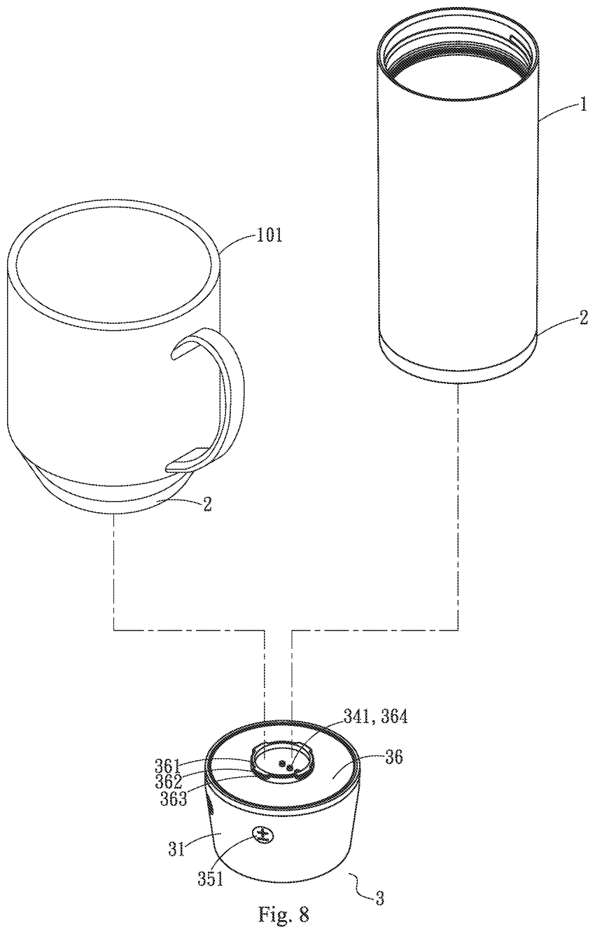

Another novelty of the invention is the ability to utilize several different cup bodies (such as a mug, a tumbler, etc.) as shown in FIG. 8, with the same heating module 2 and base unit 3.

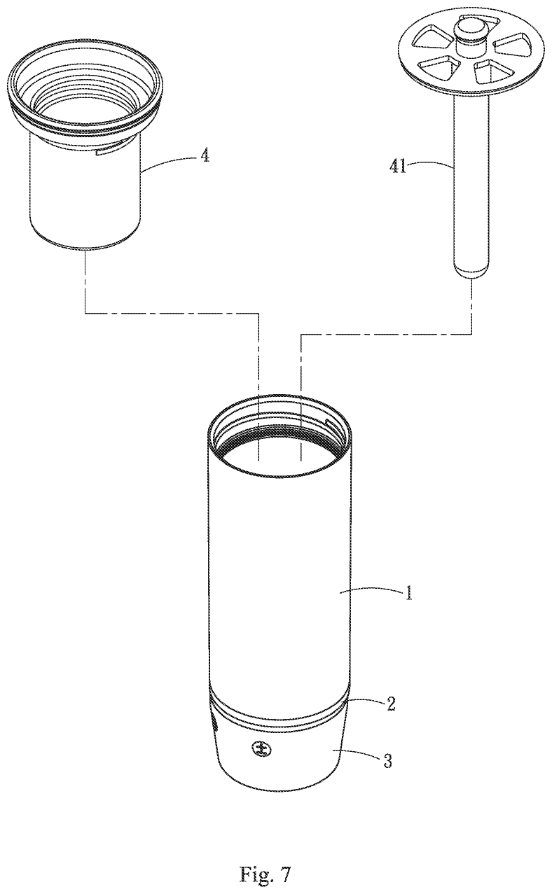

As shown in FIG. 7, a tea strainer 4 or a liquid cooler 41 can be utilized in selectively inserted into the cup body 1 to make tea or help extend the time cold liquids can remain chilled in the cup, respectively.

Having thus described the invention in connection with the several embodiments thereof, it will be evident to those skilled in the art that various revisions can be made to the several embodiments described herein without departing from the spirit and scope of the invention. It is my intention, however, that all such revisions and modifications that are evident to those skilled in the art will be included with in the scope of the following claims. Any elements of any embodiments disclosed herein can be used in combination with any elements of other embodiments disclosed herein in any manner to create different embodiments.

1. A thermostatic cup structure, comprising:
a cup body;
a cup cover;
the cup body selectively attachable to the cup cover;
the cup body having a bottom;
the cup body having a connecting recess;
a heating module;
the bottom having a connection between the connecting recess and the heating module;
the cup body having an inside surface and an outside surface;
the inside surface having an insulation layer;
the outside surface having an insulation layer;
the heating module selectively detachable from the cup body;
a heater body;
the heater body having an outer ring;
the outer ring having a convex connecting surface;
the heater body having a connection hole;
the heater body having an inner wall;
the inner wall has at least one base buckle tab;
the at least one base buckle tab has a positioner feature;
a fixing plate connected to the heater body;
the fixing plate has a conductive plate;
a first conductive column;
a heat shield covering the fixing plate;
the heating plate covering a portion of the heat shield, and electrically connected with the conductive plate and the first conductive column;
a base unit that can be selectively separated and connected from and to the heating module;
the base unit configured to hold a battery;
a control circuit board having a secondary conductive column and a control chip;
the heating module connects to the base unit;
the cup body is fitted to the heating module.

2. The thermostatic cup structure of claim 1, further comprising:
a tea strainer;
the tea strainer insertable into the cup body.

3. The thermostatic cup structure of claim 1, wherein:
the battery has an elastic connector configured to prevent the battery from shaking and vibration.

4. The thermostatic cup structure of claim 1, wherein:
the control circuit board has a port that enables an external power cord to plug into the port and enable recharging of the battery.

5. The thermostatic cup structure of claim 1, wherein:
the operation display module has a plurality of buttons to control the temperature.

6. A thermostatic cup structure, comprising:
a first cup body;
a heating module;
the first cup body selectively attachable to the heating module;
a base unit;
the heating module connected to the base unit;
the heating module configured to heat a liquid in the first cup body;
a second cup body;
the second cup body different than the first cup body;
the second cup body selectively attachable to the heating module when the first cup body is not attached to the heating module.

7. The thermostatic cup structure of claim 6, further comprising:
a cup cover;
the cup cover selectively attachable to the first cup body.

8. The thermostatic cup structure of claim 6, wherein:
the heating module comprises a heating plate;
the heating plate passes thermal energy to the first cup body.

9. The thermostatic cup structure of claim 8, wherein:
the base unit comprises a shell;
a battery housed within the shell.

10. The thermostatic cup structure of claim 9, wherein:
the base unit comprises a body;
a control circuit board mountable on the body.

11. The thermostatic cup structure of claim 10, wherein:
a display module is mountable on the body;
the display module having an indicator.

12. The thermostatic cup structure of claim 11, wherein:
a plurality of buttons control the thermal energy conducted to the heating plate.

13. The thermostatic cup structure of claim 12, wherein:
a conductive column connects to the heating plate via a heat shield.

14. The thermostatic cup structure of claim 6, further comprising:
a tea strainer insertable into the first cup body.

15. The thermostatic cup structure of claim 6, further comprising:
a cooling rod insertable into the first cup body;
the cooling rod configured to cool a liquid in the first cup body.

16. A thermostatic cup structure, comprising:
a heating module;
a base unit;
a cup body;
a control circuit board having a secondary conductive column and a control chip;
a fixing plate connected to a heater body;
the fixing plate has a conductive plate;
a first conductive column;
a heat shield covering the fixing plate;
the heating plate covering a portion of the heat shield, and electrically connected with a conductive plate and a first conductive column.

17. The thermostatic cup structure of claim 16, wherein:
the base unit is selectively attachable to the heating module;
the cup body is selectively attachable to the heating module.

18. The thermostatic cup structure of claim 17, wherein:
the heating module has a heater body;
the heater body has a connecting member.

19. The thermostatic cup structure of claim 18, wherein:
the cup body has a connecting recess;
the connecting member at least partially housed in the connecting recess with the cup body is on the heating module.
